(19) United States
(12) Patent Application Publication
(10) Pub. No.: US 2013/0039102 A1
(43) Pub. Date: Feb. 14, 2013

(54) VOLTAGE BOOSTING DEVICE AND VOLTAGE BOOSTING CIRCUIT

(71) Applicant: CHING-MING LAI, TAIPEI (TW)

(72) Inventor: CHING-MING LAI, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/413,955

(22) Filed: Mar. 7, 2012

(30) Foreign Application Priority Data
Aug. 12, 2011 (CN) 201110234341.1

(51) Int. Cl. H02M 7/00

(52) U.S. Cl. 363/101

(57) ABSTRACT

A voltage boosting circuit includes a first inductor, a first switch, a second inductor, a second switch, a first clamping diode, and a first energy storing element. When the first switch and the second switch conduct, the first and second inductors are able to store energy of a power source signal. When the first switch is not conducting and the second switch conducts, the first inductor is able to release energy to the first energy storing element. When the first switch conducts and the second switch is not conducting, the second inductor and the first energy storing element are able to release energy to a load.

### CROSS-REFERENCE TO RELATED APPLICATION

This application claims priority to Chinese Application No. 201110234341.1, filed on Aug. 12, 2011.

### BACKGROUND OF THE INVENTION

1. Field of the Invention

The invention relates to a voltage boosting device, and more particularly to a voltage boosting device with a high voltage gain.

2. Description of the Related Art

With petrol prices constantly rising and the topic of environmental conservation constantly being addressed in recent years, many countries have been aggressively promoting development of distributed power generating systems. As distributed power generation devices have the characteristic of low voltage output, they are widely used in storage devices such as photovoltaic batteries, fuel cells, storage batteries, wind turbines, etc.

With different applications and to achieve the requirement for high voltage boost in distributed power generating devices, there are ways incorporating two-stage or series-connected multi-stage voltage boosting devices. However, such ways require multiple energy conversions, which lower the conversion efficiency of the converting devices, and do not conform with practical requirements.

FIG. 1 shows a conventional interleaved voltage boosting circuit. The interleaved voltage boosting circuit has the advantages of lower input current and output voltage ripple. However, as the input voltage becomes lower, the two power switches S₁, S₂ of the voltage boosting circuit are almost always conducting (duty cycle is almost 100%). Not only does it lower the efficiency, the switching frequency of the power switches S₁, S₂ cannot be increased, which is necessary to achieve device miniaturization.

### SUMMARY OF THE INVENTION

Therefore, an object of the present invention is to provide a voltage boosting circuit to enable low voltage distributed energy to have a high voltage gain.

Accordingly, a voltage boosting circuit of the present invention is for receiving and boosting a power source signal to be supplied to a load. The voltage boosting circuit includes a first inductor, a first switch, a second inductor, a second switch, a first clamping diode, and a first energy storing element.

The first inductor has a first terminal for receiving the power source signal, and a second terminal electrically coupled to the first switch. The second inductor has a first terminal for receiving the power source signal, and a second terminal electrically coupled to the second switch. The first clamping diode has an anode electrically coupled to a junction of the first inductor and the first switch, and a cathode to be electrically coupled to the load. The first energy storing element has a first terminal electrically coupled to a junction of the second inductor and the second switch, and a second terminal electrically coupled to the cathode of the first clamping diode. An output diode has an anode electrically coupled to the cathode of the first camping diode, and a cathode to be electrically coupled to the load. An output capacitor is electrically coupled to the cathode of the output diode.

When the first switch and the second switch conduct, the first inductor and the first switch form a first loop while the second inductor and the second switch form a second loop. The first and second inductors are thus able to store energy of the power source signal. When the first switch is not conducting and the second switch conducts, the first inductor, the first clamping diode, the first energy storing element and the second switch form a third loop, and the first inductor is able to release energy to the first energy storing element. When the first switch conducts and the second switch is not conducting, the second inductor, the first energy storing element, the output diode and the output capacitor form a fourth loop, and the second inductor and the first energy storing element are able to release energy to the load. Hence, the goal of boosting the input power is achieved.

To make sure the conducting periods of the first and second switches overlap to provide power continuously, the duty cycles of the first and second switches are preferably greater than 50%, i.e., 0.5<D<1.

To further increase the power from the input power source, the voltage boosting circuit can also include a sensing voltage booster circuit. The sensing voltage booster circuit includes a first rectifying diode, a second rectifying diode, a first filtering capacitor, a second filtering capacitor, a first coupling inductor and a second coupling inductor.

The first rectifying diode has an anode and a cathode, and the cathode of the first rectifying diode is to be electrically coupled to the load. The second rectifying diode has an anode electrically coupled to the cathode of the output diode, and a cathode electrically coupled to the anode of the first rectifying diode. The first filtering capacitor has a first terminal electrically coupled to the cathode of the first rectifying diode, and a second terminal. The second filtering capacitor has a first terminal electrically coupled to the second terminal of the first filtering capacitor, and a second terminal electrically coupled to the anode of the second rectifying diode. The first coupling inductor cooperates with the first inductor to form a transformer. The first coupling inductor has a first terminal electrically coupled to the cathode of the second rectifying diode, and a second terminal. The second coupling inductor cooperates with the second inductor to form another transformer, the second coupling inductor has a first terminal electrically coupled to the second terminal of the first coupling inductor, and a second terminal electrically coupled to a junction of the first filtering capacitor and the second filtering capacitor. When the first switch conducts, the first coupling inductor is able to release energy to the first filtering capacitor. When the second switch conducts, the second coupling inductor is able to release energy to the second filtering capacitor. When the first switch conducts and the second switch is not conducting, the first filtering capacitor and the second filtering capacitor are able to release energy to the load.

The voltage boosting circuit of the present invention can also include a first inductor, a first switch, a second inductor, a second switch, multiple clamping diodes, and multiple energy storing elements.

The first inductor has a first terminal for receiving the power source signal, and a second terminal. The first switch is electrically coupled to the second terminal of the first inductor. The second inductor has a first terminal for receiving the power source signal, and a second terminal. The second switch is electrically coupled to the second terminal of the second inductor. The multiple clamping diodes are series connected. The number of energy storing elements corresponds to the number of clamping diodes. Each energy storing element has a first terminal, and a second terminal electrically coupled to a cathode of the corresponding clamping diode. The first terminals of some of the energy storing elements are electrically coupled to a junction of the first inductor and the first switch, and the first terminals of the rest of the energy storing elements are electrically coupled to a junction of the second inductor and the second switch.

Therefore, when the first switch and the second switch conduct, the first and second inductors are able to store energy of the power source signal. When the first switch is not conducting and the second switch conducts, the first inductor is able to release energy to the energy storing elements electrically coupled to the junction of the second inductor and the second switch, and the energy storing elements electrically coupled to the junction of the first inductor and the first switch is able to release energy to the load.

Similarly, the voltage boosting circuit having multiple clamping diodes and multiple energy storing elements can also include the sensing voltage booster circuit described above to obtain an even higher voltage boost.

Also, the voltage boosting circuit of the present invention can be integrated into a voltage boosting device. The voltage boosting device can include a control circuit and the aforementioned voltage boosting circuit. The first switch can be an N-type metal oxide semiconductor field effect transistor having a drain electrically coupled to the second terminal of the first inductor, a gate electrically coupled to the control circuit, and a source connected to ground. The second switch can be an N-type metal oxide semiconductor field effect transistor having a drain electrically coupled to the second terminal of the second inductor, a gate electrically coupled to the control circuit, and a source connected to ground.

The effect of the voltage boosting device of the present invention is to provide low voltage/high current power input, integrated single-stage power conversion that can achieve high voltage gain in a single power conversion process, and having high conversion efficiency. Also, the voltages of the first switch, the second switch and the clamping diodes of the voltage boosting circuit are substantially lower than the conventional voltage boosting circuit. Accordingly, the conducting and switching losses of the circuit elements, and the problem of reverse recovery loss are all substantially reduced to further increase the conversion efficiency.

### BRIEF DESCRIPTION OF THE DRAWINGS

Other features and advantages of the present invention will become apparent in the following detailed description of the preferred embodiments with reference to the accompanying drawings, of which:

FIG. 1 shows a conventional interleaved voltage boosting circuit;

FIG. 2 shows the first embodiment of the voltage boosting device of the present invention;

FIG. 3 shows current directions of the first and second loops when the first switch and the second switch of the voltage boosting circuit of the first preferred embodiment are both conducting;

FIG. 4 shows current directions of second and third loops when the first switch is not conducting while the second switch conducts;

FIG. 5 shows current directions of first and fourth loops when the first switch conducts while the second switch is not conducting;

FIG. 6 shows the second embodiment of the voltage boosting device of the present invention;

FIG. 7 shows the third embodiment of the voltage boosting device of the present invention;

FIG. 8 is a characteristic curve plot illustrating voltage gains of the conventional interleaved voltage boosting circuit and the first, second and third embodiments of the voltage boosting device of the present invention;

FIG. 9 is a waveform diagram of the power source signal, output voltage and voltage across the output diode of the third embodiment;

FIG. 10 shows the fourth embodiment of the voltage boosting device of the present invention;

FIG. 11 shows current directions of first, second, seventh and eighth loops when both first and second switches of the voltage boosting circuit of the fourth preferred embodiment conduct;

FIG. 12 shows current directions of second, third and eighth loops when the first switch is not conducting while the second switch conducts;

FIG. 13 shows current directions of first, fourth and seventh loops when the first switch conducts while the second switch is not conducting;

FIG. 14 shows the fifth embodiment of the voltage boosting device of the present invention;

FIG. 15 shows the sixth embodiment of the voltage boosting device of the present invention; and

FIG. 16 is a characteristic curve plot illustrating voltage gains of the conventional interleaved voltage boosting circuit and the fourth, fifth and sixth embodiments of the voltage boosting device of the present invention.

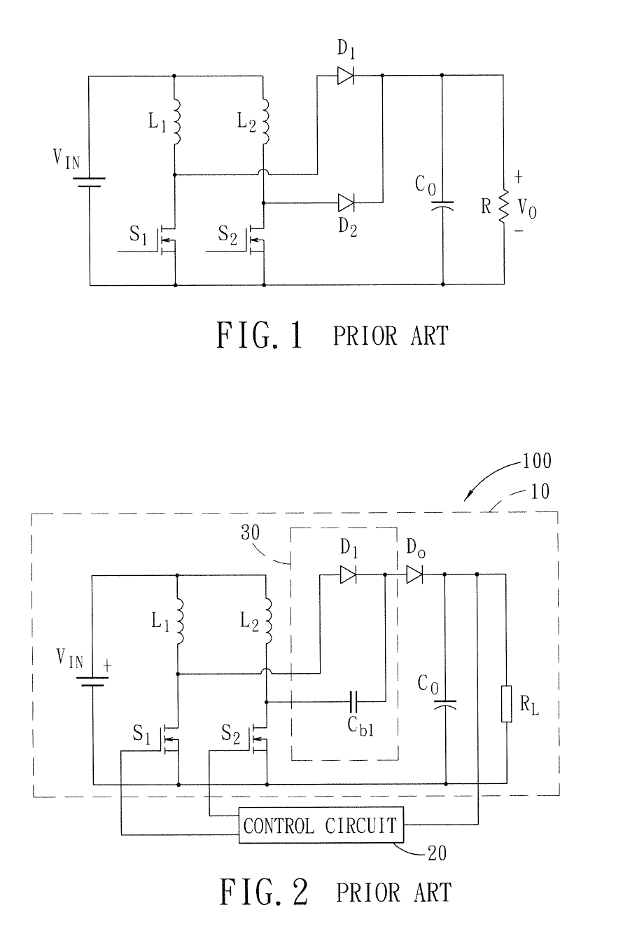

### DETAILED DESCRIPTION OF THE PREFERRED EMBODIMENTS

Before the present invention is described in greater detail, it should be noted that like elements are denoted by the same reference numerals throughout the disclosure.

FIG. 2 shows the first embodiment of the voltage boosting device of the present invention. The voltage boosting device 100 is an interleaved/multiphase-structured voltage booster that can be used in battery charging/discharging systems in hybrid power vehicles, home use direct current micro-grid power generating systems, power factor correctors, high voltage drivers for high intensity discharge (HID) head lights in vehicles, alternative power generating systems that are based on solar energy/wind power/fuel cells, medical electronic instruments, such as X-ray machines, ozone generators, etc.

In the first embodiment, the voltage boosting device 100 receives and boosts a low voltage/high current power source signal V_{IN} to be supplied to electronic devices (i.e., the load R_{L}). The voltage boosting device 100 includes a voltage boosting circuit 10 and a control circuit 20. The voltage boosting circuit 10 includes a first inductor L₁, a first switch S₁, a second inductor L₁, a second switch S₂, an auxiliary step-up unit 30, an output diode D_{O}, and an output capacitor C_{O}.

The first inductor L₁ has a first terminal for receiving the power source signal V_{IN}, and a second terminal. The first switch S₁ is an N-type metal oxide semiconductor field effect transistor having a drain (D) electrically coupled to the second terminal of the first inductor L₁, a gate (G) electrically coupled to the control circuit 20, and a source (3) connected to ground. The first switch S₁ is controlled by the control circuit 20 to conduct or not conduct. The second inductor L₂ has a first terminal for receiving the power source signal V_{IN}, and a second terminal. The second switch S₂ is also an N-type metal oxide semiconductor field effect transistor having a drain (D) electrically coupled to the second terminal of the second inductor L₂, a gate (G) electrically coupled to the control circuit 20, and a source (S) connected to ground. The second switch S₂ is controlled by the control circuit 20 to conduct or not conduct.

The auxiliary step-up unit 30 includes a clamping diode D₁ and an energy storing element C_{b1}. The clamping diode D₁ has an anode electrically coupled to a junction of the first inductor L₁ and the first switch S₁ (i.e. the drain of the first switch S₁), and a cathode electrically coupled to the output diode D_{O}. The energy storing element C_{b1} is exemplified as an energy storing capacitor, and has a first terminal electrically coupled to a junction of the second inductor L₁ and the second switch S₂ (i.e., the drain of the second switch S₂), and a second terminal electrically coupled to the cathode of the first clamping diode D₁. The output diode D_{O} has an anode electrically coupled to the cathode of the clamping diode D₁, and a cathode electrically coupled to the load R_{L}. The output capacitor C_{O} is electrically coupled between the cathode of the output diode D_{O} and ground.

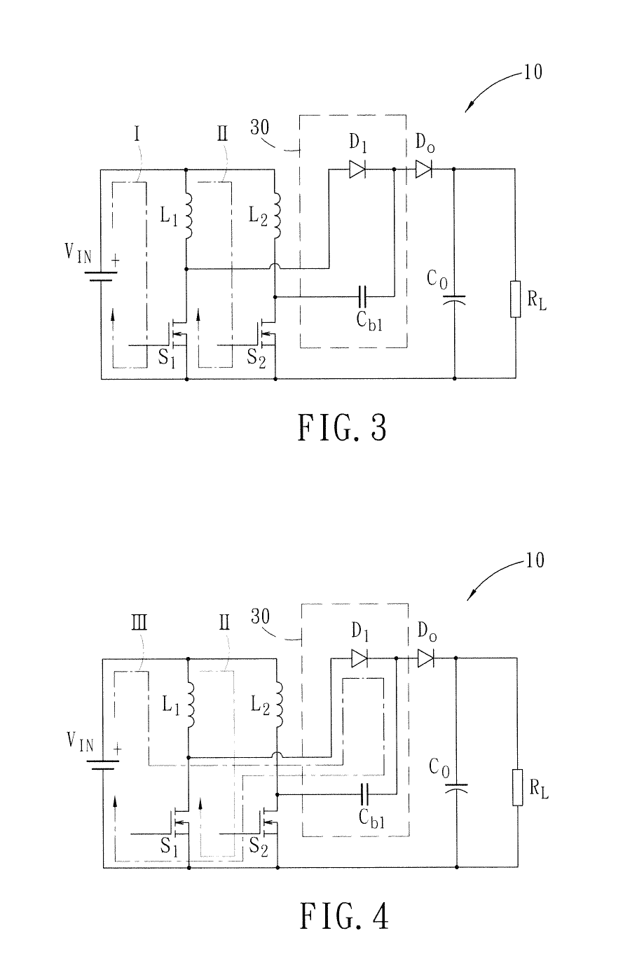

When the control circuit 20 controls the first switch S₁ and the second switch S₂ to conduct, the first inductor L₁ and the first switch S₁ form a first loop I, while the second inductor L and the second switch S₂ form a second loop II, as shown in FIG. 3. The first and second inductors L₁, L₂ will store energy of the power source signal V_{IN} at the time.

Referring to FIGS. 2 and 4, when the control circuit 20 controls the first switch S₁ to not conduct and the second switch S₂ to conduct, the first inductor L₁, the clamping diode D₁, the energy storing element C_{b1} and the second switch S₂ form a third loop III, and the first inductor L₁ will release energy to the energy storing element C_{b1} through the clamping diode D₁. Meanwhile, the second inductor L₂ and the second switch S₂ still form the second loop II, and the second inductor L₂ continues to store energy of the power source signal V_{IN}.

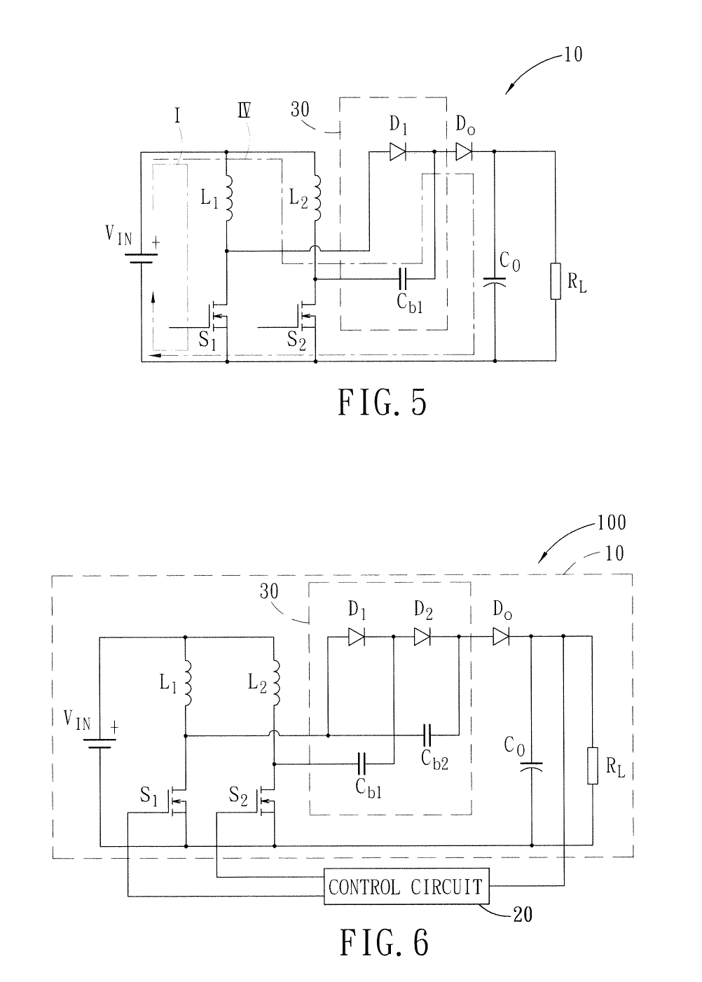

Referring to FIGS. 2 and 5, when the control circuit 20 controls the first switch S₁ to conduct and the second switch S₂ to not conduct, the second inductor L₂, the energy storing element C_{b1}, the output diode D_{O} and the output capacitor C_{O} form a fourth loop IV, and the power source signal V_{IN}, the second inductor L₂ and the energy storing element C_{b2} will provide energy to the output capacitor C_{O} for use by the electronic devices (i.e., the load R_{L}). Meanwhile, the first inductor L₁ and the first switch S₁ still form the first loop I, and the first inductor L₁ continues to store energy of the power source signal V_{IN}.

In other words, by having the first switch S₁ not conduct and the second switch S₂ conduct, the energy storing element C_{b1} of the auxiliary step-up unit 30 can store energy of the first inductor L₁, and by having the first switch S₁ conduct and the second switch S₂ not conduct, the energy of the energy storing element C_{b1} and the stored energy of the second inductor L₁, are released together to the load R_{L}, thus achieving the goal of boosting the input power source signal V_{IN}, with the voltage gain as follows:

$$\frac{2}{1 - D}$$

Wherein D is the duty cycles of the first switch S₁ and the second switch S₂. Therefore, comparing the voltage boosting circuit 10 of the present invention and the conventional interleaved voltage boosting circuit, with the first and second switches S₁, S₂ having lower duty cycles, and achieving the same step-up ratio, not only can conducting loss and switching loss be reduced, the loss created by the reverse recovery of the output diode D_{O} is also reduced, hence increasing the overall conversion efficiency. Also, the first switch S₁, the second switch S₂ and the clamping diode D₁ have the characteristic of low switch voltage stress, which further increases the reliability and the efficiency in high voltage conversion, and without the need of an active circuit control to operate the auxiliary step-up unit 30, the production cost of the voltage boosting device 100 may be further reduced.

FIG. 6 shows the second embodiment of the voltage boosting device 100 of the present invention. The difference between the first embodiment and the second embodiment resides in that the auxiliary step-up unit 30 further includes another clamping diode D₂ and another energy storing element C_{b2}. To simplify the description process, the two clamping diodes D₁, D₂ are respectively defined as the first clamping diode D₁ and the second clamping diode D₂, and the two energy storing elements C_{b1}, C_{b2} are respectively defined as the first energy storing element Cₕᵢ and the second energy storing element C_{b2}.

In this embodiment, the first clamping diode D₁ has an anode electrically coupled to a junction of the first inductor L₁ and the first switch S₁, and a cathode electrically coupled to a cathode of the second clamping diode D₂. The first energy storing element C_{b1} has a first terminal electrically coupled to a junction of the second inductor L₂ and the second switch S₂, and a second terminal electrically coupled to the cathode of the first clamping diode D₁. The second clamping diode D₂ has a cathode electrically coupled to the anode of the output diode D_{O}. The second energy storing element C_{b2} has a first terminal electrically coupled to the junction of the first inductor L₁ and the first switch S₁, and a second terminal electrically coupled to the cathode of the second clamping diode D₂.

Similarly, when the first switch S₁ and the second switch S₂ both conduct, the first inductor L₁ and the first switch S₁ form a first loop I, while the second inductor L₂ and the second switch S₂ form a second loop II. The first and second inductors L₁, L₂ will store energy of the power source signal V_{IN}.

When the first switch S₁ is not conducting and the second switch S₂ conducts, the first inductor L₁, the first clamping diode D₁, the first energy storing element C_{b1} and the second switch S form a fifth loop V. The first clamping diode D₁ conducts and the first inductor L₁ will release energy to the first energy storing element C_{b1}, and the second energy storing element C_{b2} will release energy to the output capacitor C_{O}. Meanwhile, the second inductor L₂ and the second switch S₂ still form the second loop II, and the second inductor L₂ continues to store energy of the power source signal V_{IN}.

When the first switch S₁ conducts and the second switch S₂ is not conducting, the second inductor L₂, the first energy storing element C_{b1}, the second clamping diode D₂, the output diode D_{O} and the output capacitor C_{O} form a sixth loop VI. The power source signal V_{iN}, the second inductor L₂ and the first energy storing element C_{b1} will provide energy to the output capacitor C_{O}, and the first inductor L₁ will release energy to the second energy storing element C_{b2}. Meanwhile, the first inductor L₁ and the second switch S₁ still form the first loop I, and the first inductor L₁ continues to store energy of the power source signal V_{IN}.

Similarly, when the first switch S₁ is not conducting and the second switch S₂ conducts, the energy storing element C_{b1} of the auxiliary step-up unit 30 can store energy of the first inductor L₁, while the second energy storing element C_{b2} can release energy to the load R_{L}. When the first switch S₁ conducts and the second switch S₂ is not conducting, the second energy storing element C_{b2} will store energy of the first inductor L₁, and the energy of the first energy storing element C_{b1} and the stored energy of the second inductor L₂ are released together to the load R_{L}, thus achieving the goal of boosting the input power source signal V_{IN}. The voltage boosting circuit 10 of the second embodiment has the voltage gain as follows:

$$\frac{3}{1 - D}$$

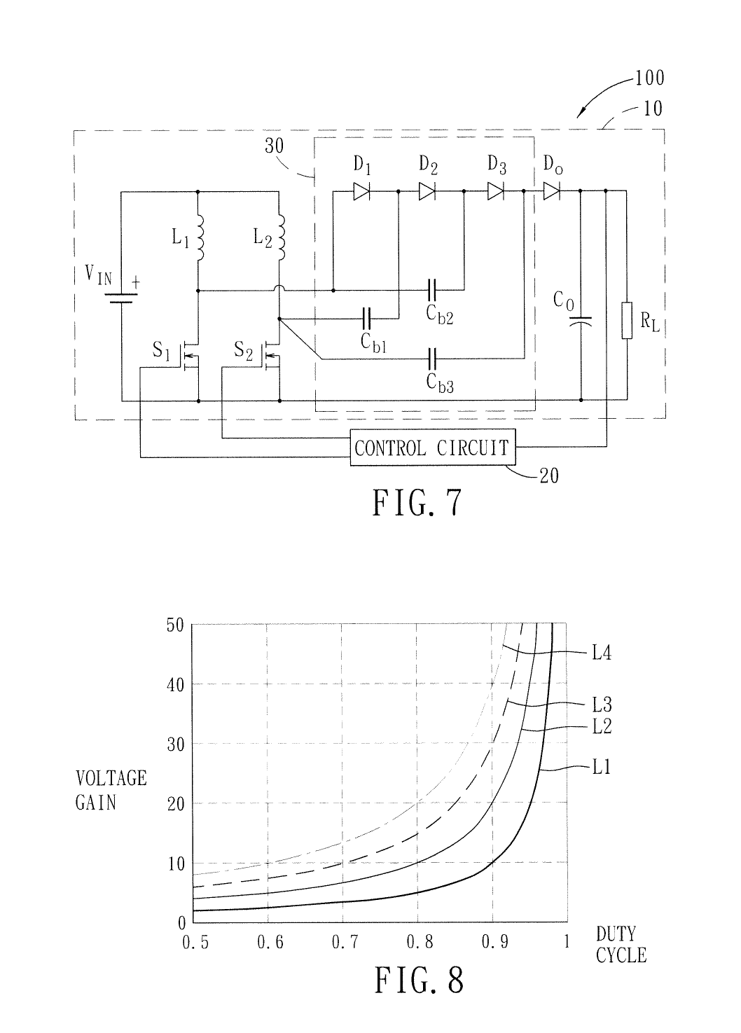

FIG. 7 shows the third embodiment of the voltage boosting device 100 of the present invention. The difference between the first embodiment and the third embodiment resides in that the auxiliary step-up unit 30 can include multiple clamping diodes and multiple energy storing elements (storage capacitors). This embodiment is exemplified as using three clamping diodes D₁, D₂, D₃ and three energy storing elements C_{b1}, C_{b3}, which are respectively the first clamping diode D₁, the second clamping diode D₂, the third clamping diode D₃, the first energy storing element C_{b1}, the second energy storing element C_{b2}, and the third energy storing element C_{b3}.

The first clamping diode D₁ has an anode electrically coupled to a junction of the first inductor L₁ and the first switch S₁, and a cathode electrically coupled to an anode of the second clamping diode D₂. The first energy storing element C_{b1} has a first terminal electrically coupled to a junction of the second inductor and the second switch S₂, and a second terminal electrically coupled to the cathode of the first clamping diode D₁. The second clamping diode D₂ has a cathode electrically coupled to an anode of the third clamping diode D₃. The second energy storing element C_{b2} has a first terminal electrically coupled to the junction of the first inductor L₁ and the first switch S₁, and a second terminal electrically coupled to the cathode of the second clamping diode D₂. The third clamping diode D₃ has a cathode electrically coupled to the anode of the output diode D_{O}. The third energy storing element C_{b3} has a first terminal electrically coupled to the junction of the second inductor L₂ and the second switch S₂, and a second terminal electrically coupled to the cathode of the third clamping diode D.

In other words, the three clamping diodes D₁, D₂, D₃ are interconnected in series, and the first energy storing element C_{b1}, the second energy storing element C_{b2} and the third energy storing element C₁ each have the second terminal electrically coupled to the respective cathode of the first clamping diode D₁, the second clamping diode D₂, the third clamping diode D₃. Some of the energy storing elements (the second energy storing element C_{b2}) has the first terminal electrically coupled to the junction of the first inductor L₁ and the first switch S₁, and the rest of the energy storing elements (the first and third energy storing elements C_{b1}, C_{b3}) have their first terminals electrically coupled to the junction of the second inductor L₂ and the second switch S₂.

Similarly, when the first switch S₁ and the second switch S both conduct, the first and second inductors L₁, L₂ will store energy of the power source signal V_{IN}.

When the first switch S₁ is not conducting and the second switch S₂ conducts, the first inductor L₁ will release energy to the energy storing elements electrically coupled to the junction of the second inductor L₂ and the second switch S₂ (the first and third energy storing elements C_{b1}, C_{b3}), and the energy storing element electrically coupled to the junction of the first inductor L₁ and the first switch S₁ (the second energy storing element C_{b2}), will release energy to the output capacitor C_{O}.

When the first switch S₁ conducts and the second switch S₂ is not conducting, the energy storing elements electrically coupled to the junction of the second inductor L₂ and the second switch S₂ (the first and third energy storing elements C_{b1}, C_{b3}) will release energy to the output capacitor C_{O}, and the energy storing element electrically coupled to the junction of the first inductor L₁ and the first switch S₁ (the second energy storing element C_{b2}) will store energy of the first inductor L₁. Thus, the goal of boosting the input power source signal V_{IN} is achieved, and the voltage boosting circuit 10 of the third embodiment has the voltage gain as follows:

$$\frac{4}{1 - D}$$

FIG. 8 is a characteristic curve plot illustrating voltage gains of the conventional interleaved voltage boosting circuit and the three embodiments of the voltage boosting circuit 10 of the present invention. The horizontal axis represents the duty cycles of the first and second switches S₁, S₂, and the vertical axis represents the voltage gain. L1 represents the characteristic curve of the conventional interleaved voltage boosting circuit, and L2-L4 represent the characteristic curves of the first to third embodiments of the voltage boosting circuit 10, respectively. As shown on the characteristic curve plot, the voltage gains in the embodiments of the voltage boosting circuit 10 of the present invention are substantially greater than that of the conventional interleaved voltage boosting circuit, regardless of the duty cycles of the first and second switches S₁, S₂, which means the voltage boosting device 100 of the present invention can indeed increase the overall conversion efficiency and provide a higher voltage power output. The properties of the conventional interleaved voltage boosting circuit and the three embodiments of the voltage boosting circuit 10 of the present invention are presented in the following table:

TABLE 1

| | Conventional | Voltage boosting circuit of | | |
|---|---|---|---|---|
| | voltage | the present invention | | |
| | boosting | First | Second | Third |
| | circuit | embodiment | embodiment | embodiment |
| Voltage gain | 1/(1-D) | 2/(1-D) | 3/(1-D) | 4/(1-D) |
| Voltage across | Vₒ | ½ Vₒ | ⅓ Vₒ | ¼ Vₒ |
| the switch | | | | |
| Voltage across | Vₒ | ½ Vₒ | ⅓ Vₒ | ¼ Vₒ |
| the output | | | | |
| diode | | | | |
| Voltage across | — | Vₒ | ⅔ Vₒ | ½ Vₒ |
| the clamping | | | | |
| diode | | | | |

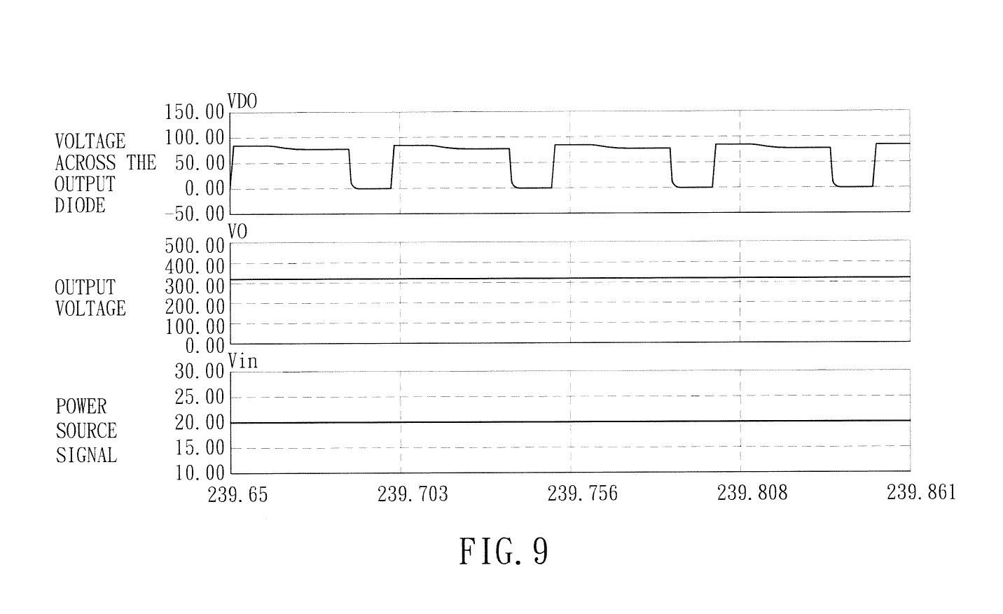

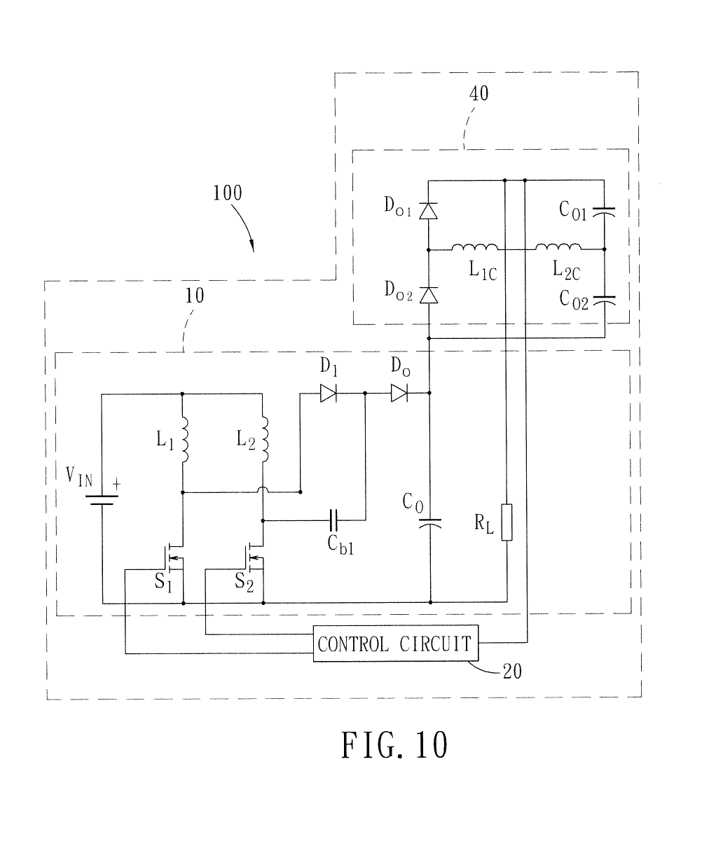

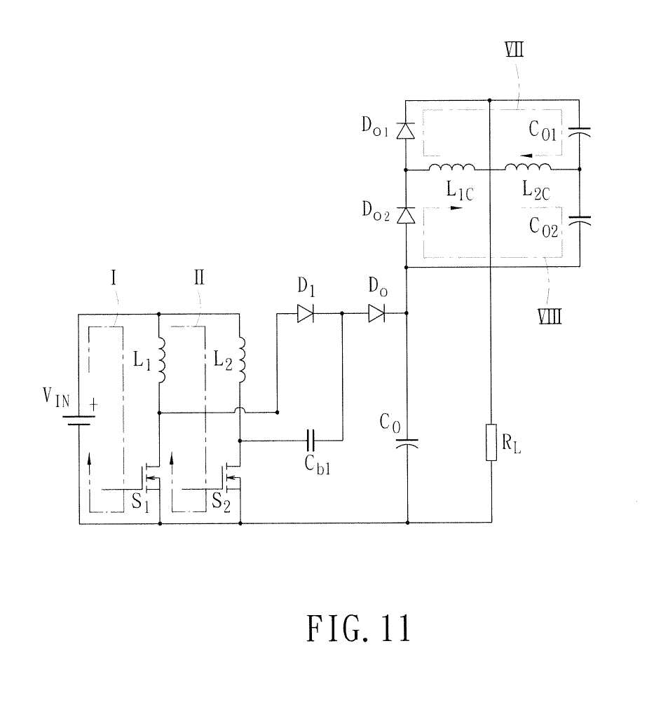

On a more specific note, in the three embodiments described above, the duty cycles of the first and second switches S₁, S₂ both have to be greater than 50% (i.e. 0.5<D<1), and the first switch S₁ and the second switch S₂ have their conducting periods overlapped to provide continuous power. While setting up the embodiments, the power source signal V_{IN} is set to be 20V, the first and second inductors L₁, L₂ have the inductance value of 200 μH, the energy storing element (s) C_{b1} (C_{b1}=C_{b2}=C_{b3} has the capacitance value of 3.3 μF, the output capacitor C_{O} has the capacitance value of 200 μF, and the duty cycles of the first and second switches S₁, S₂ are both set to be 75%. Therefore, with the above setting and looking at the third embodiment (FIG. 7), the voltage boosting device 100 can provide 320V (=20×4/(1−0.75)) of output voltage, as shown in FIG. 9.

FIG. 10 illustrates the fourth embodiment of the voltage boosting device 100 of the present invention. The voltage boosting device 100 includes a voltage boosting circuit 10, a control circuit 20, and a sensing voltage booster circuit 40. The voltage boosting circuit 10 includes a first inductor L₁, a first switch S₁, a second inductor L₁, a second switch S₂, an auxiliary step-up unit 30, an output diode D_{O}, and an output capacitor C_{O}. The connections, functions and operations of the components in the auxiliary step-up unit 30 and the voltage boosting circuit 10 are the same as those described in the first embodiment, and are not repeated herein.

The sensing voltage booster circuit 40 includes a first rectifying diode D_{O1}, a second rectifying diode D_{O2}, a first coupling inductor L_{1C}, a second coupling inductor L_{2C}, a first filtering capacitor C_{O1l} and a second filtering capacitor C_{O2}.

The first rectifying diode D_{O1} has an anode electrically coupled to a cathode of the second rectifying diode D_{O2}, and a cathode electrically coupled to a first terminal of the first filtering capacitor C_{O1} and the load R_{L} (back end terminal electronic device). The second rectifying diode D_{O1} has an anode electrically coupled to the cathode of the output diode D_{O} and the output capacitor C_{O}. The first filtering capacitor C_{O1} has a second terminal electrically coupled to a first terminal of the second filtering capacitor C_{O2}. The second filtering capacitor C_{O2} has a second terminal electrically coupled to a junction of the second rectifying diode D_{O2} and the output capacitor C_{O} (the anode of the second rectifying diode D_{O2}). The first coupling inductor L_{1C} cooperates with the first inductor L₁ to form a transformer, the second coupling inductor L_{2C} cooperates with the second inductor L₂ to form another transformer, the first coupling inductor L_{1C} and the second coupling inductor L_{2C} are series connected, the first coupling inductor L_{1C} has a first terminal electrically coupled to a junction of the first rectifying diode D_{O1} and the second rectifying diode D_{O2} (the cathode of the second rectifying diode D_{O2}), and the second coupling inductor L_{2C} has a second terminal electrically coupled to a junction of the first filtering capacitor C_{O1} and the second filtering capacitor C_{O2}.

Referring to FIGS. 10 and 11, when the first switch S₁ and the second switch S₂ conduct, the current paths of the first inductor L₁ and the second inductor L₂ are the same as described in the previous embodiments. The first inductor L₁ and the first switch S₁ form a first loop I, the second inductor L₂ and the second switch S₂ form a second loop II, and the first and second inductors L₁, L₂ will store energy of the power source signal V_{IN}. The difference is that, at this instance, the first coupling inductor L_{1C} senses the first inductor L₁ storing energy and thus releases energy. The first coupling inductor L_{1C}, the first rectifying diode D_{O1}, and the first filtering capacitor C_{O1} and the second coupling inductor L_{2C} form a seventh loop VII, and the first filtering capacitor C_{O1} will store energy. Similarly, the second coupling inductor L_{2C} senses the second inductor L₂ storing energy and thus releases energy along the current path of the second coupling inductor L_{2C}, the second filtering capacitor CO2, the second rectifying diode DO2, and the first coupling inductor L1C that form an eighth loop VIII, where the second filtering capacitor CO2 will store energy.

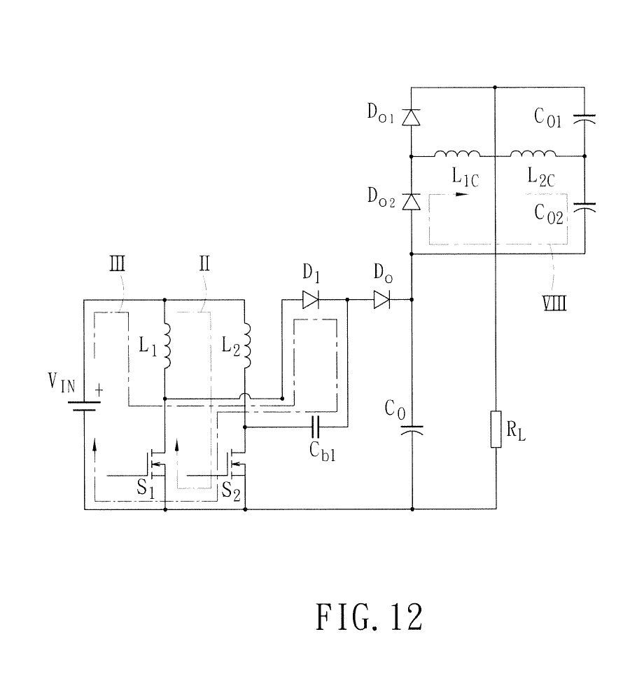

Referring to FIGS. 10 and 12, when the control circuit 20 controls the first switch S₁ to not conduct and the second switch S₂ to conduct, the first inductor L₁, the clamping diode D₁, the energy storing element C_{b1} and the second switch S₂ form a third loop III, and the first inductor L₁ will release energy to the energy storing element C_{b1} through the clamping diode D₁. Meanwhile, the second inductor L₂ and the second switch S₂ still form the second loop II, the second coupling inductor L_{2C}, the second filtering capacitor C_{O2}, the second rectifying diode D_{O2} and the first coupling inductor L_{1C} still form the eighth loop VIII, and the second inductor L₂ continues to store energy while the second coupling inductor L_{2C} continues to release energy.

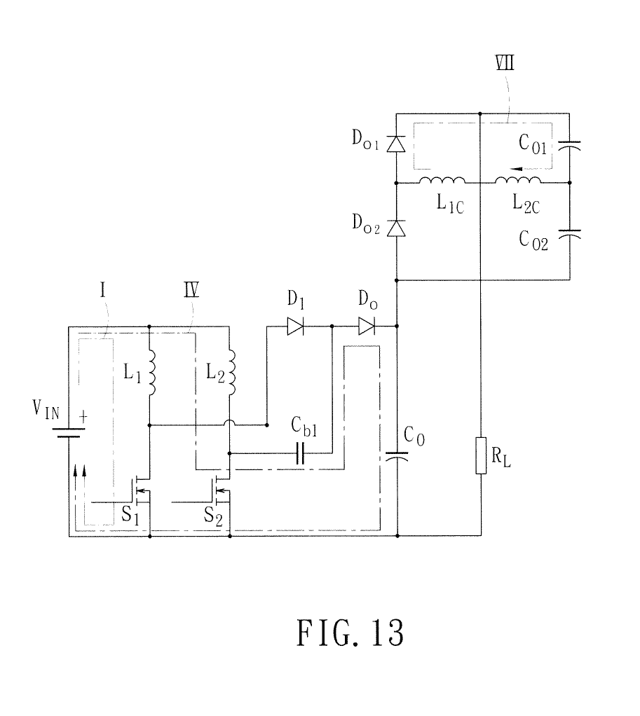

Referring to FIGS. 10 and 13, when the control circuit 20 controls the first switch S₁ to conduct and the second switch S₂ to not conduct, the second inductor L₂, the energy storing element C_{b1}, the output diode D_{O} and the output capacitor C_{O} form a fourth loop IV, and the power source signal V_{IN}, the second inductor L₂ and the energy storing element C_{b1} provide energy to the output capacitor C_{O}. Meanwhile, the first inductor L₁ and the first switch S₁ still form the first loop I, the first coupling inductor L_{1C}, the first rectifying diode D_{O1}, the first filtering capacitor C_{O1} and the second coupling inductor L_{2C} still form the seventh loop VII, and the first inductor L₁ continues to store energy while the first coupling inductor L_{1C} continues to release energy.

On a more specific note, in this embodiment, the output capacitor C_{O}, the first filtering capacitor C_{O1} and the second filtering capacitor C_{O2} will release energy to the load R_{L} at the same time, which will further increase the voltage of the power source signal V_{IN}, and the voltage gain is as follows:

$$\frac{2 + {N}_{1} + {N}_{2}}{1 - D}$$

Wherein D is the duty cycle of the first switch S₁ and the second switch S₂, N₁ is the turn ratio of the first inductor L₁ and the first coupling inductor L_{1C}, and N₂ is the turn ratio of the second inductor L₂ and the second coupling inductor L_{2C}. In practice, the turn ratio of the first inductor L₁ and the first coupling inductor L_{1C} is the same as the turn ratio of the second inductor L₂ and the second coupling inductor L_{2C} (i.e., N₁=N=N) for ease of control. Therefore, the voltage gain can be simplified as follows:

$$\frac{2 + 2 N}{1 - D}$$

Therefore, the voltage boosting circuit 10 can use lower duty cycle of the first switch S₁ and the second switch S₂ to achieve higher step-up ratio. Not only are conducting loss and switching loss reduced, the reverse recovery loss of the output diode D_{O} is also reduced, thereby increasing the overall conversion efficiency. Also, the first switch S₁, the second switch S₂ and the clamping diode D₁ have the property of low voltage stress that can further increase the reliability and the high energy conversion efficiency, and without the need of any active circuit control to operate the auxiliary step-up unit 30 and the sensing voltage booster circuit 90, the production cost of the voltage boosting device 100 is also reduced.

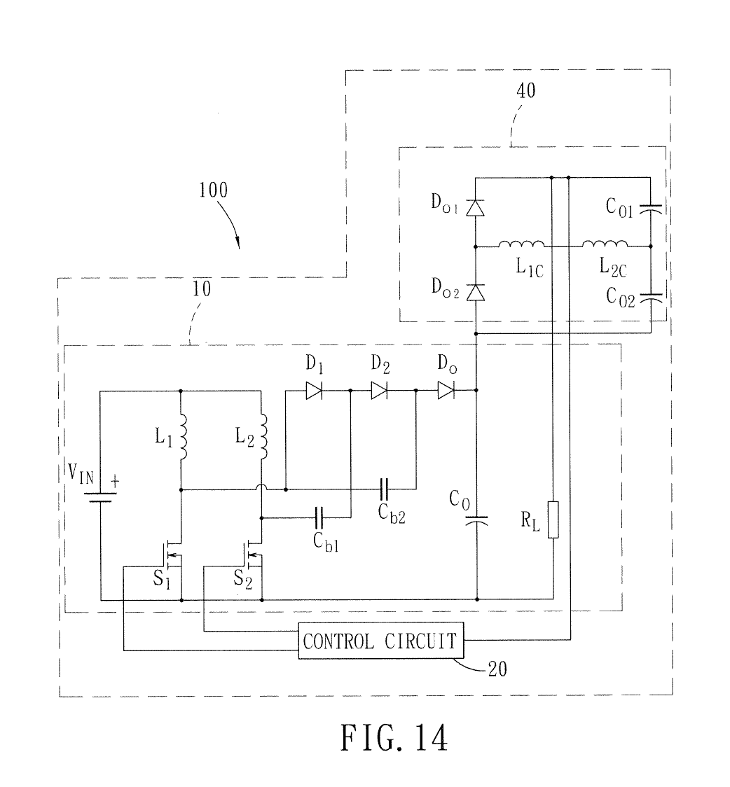

FIG. 14 illustrates the fifth embodiment of the voltage boosting device 100 of the present invention. The voltage boosting device 100 includes a voltage boosting circuit 10, a control circuit 20 and a sensing voltage booster circuit 40. In this embodiment, the connections and functions of the components in the control circuit 20 and the voltage boosting circuit 10 are the same as those described in the second embodiment, and the connections and functions of the components in the sensing voltage booster circuit 40 are the same as those described in the fourth embodiment.

Similarly, when the first switch S₁ and the second switch S₂ conduct, the states of the components are the same as those described in the fourth embodiment. The first inductor L₁ and the first switch S₁ form a first loop I, the second inductor L₂ and the second switch S₂ form a second loop II, the first coupling inductor L_{1C}, the first rectifying diode D_{O1}, the first filtering capacitor C_{O1} and the second coupling inductor L_{2C} form a seventh loop VII, and the second coupling inductor L_{2C}, the second filtering capacitor C_{O2}, the second rectifying diode D_{O2} and the first coupling inductor L_{1C} form the eighth loop VIII. The first and second inductors L₁, L₂ will store energy of the power source signal V_{IN}, the first filtering capacitor C_{O1} will store energy of the first coupling inductor L_{1C}, and the second filtering capacitor C_{O2} will store energy of the second coupling inductor L_{2C}.

When the first switch S₁ is not conducting and the second switch S₂ conducts, the first inductor L₁, the first clamping diode D₁, the first energy storing element C_{b1} and the second switch S₂ form a fifth loop V like in the second embodiment, the first clamping diode D₁ conducts and the first inductor L₁ will release energy to the first energy storing element C_{b1}, and the second energy storing element C_{b2} will release energy to the output capacitor C_{O}. Meanwhile, the second inductor L₂ and the second switch S₂ still form the second loop II, the second coupling inductor L_{2C}, the second filtering capacitor C_{O2}, the second rectifying diode D_{O2} and the first coupling inductor L_{1C} still form the eighth loop VIII, and the second inductor L₂ continues to store energy while the second coupling inductor L_{2C} continues to release energy.

When the first switch S₁ conducts and the second switch S₂ is not conducting, the second inductor L₂, the first energy storing element C_{O1}, the second clamping diode D₂, the output diode D_{O} and the output capacitor C_{O} form a sixth loop VI like in the second embodiment, the power source signal V_{IN}, the second inductor L₂ and the first energy storing element C_{b1} provide energy to the output capacitor C_{O}, and the first inductor L₁ will release energy to the second energy storing element C_{b2}. Meanwhile, the first inductor L₁ and the first switch S₁ still form the first loop I, the first coupling inductor L_{1C}, the first rectifying diode D_{O}1, the first filtering capacitor C_{O1} and the second coupling inductor L_{2C} still form the seventh loop VII, and the first inductor L₁ continues to store energy while the first coupling inductor L_{1C} continues to release energy.

Similarly, the output capacitor C_{O} and the first and second filter capacitors C_{O1}, C_{O2} of this embodiment will simultaneously release energy to the load R_{L} to further increase the voltage of the power source signal V_{IN}, with the voltage gain as follows:

$$\frac{3 + 2 N}{1 - D}$$

Wherein the turn ratios between the first inductor L₁ and the first coupling inductor L_{1c}, and between the second inductor L₂ and the second coupling inductor L_{2C} are the same, i.e., N₁=N₂=N.

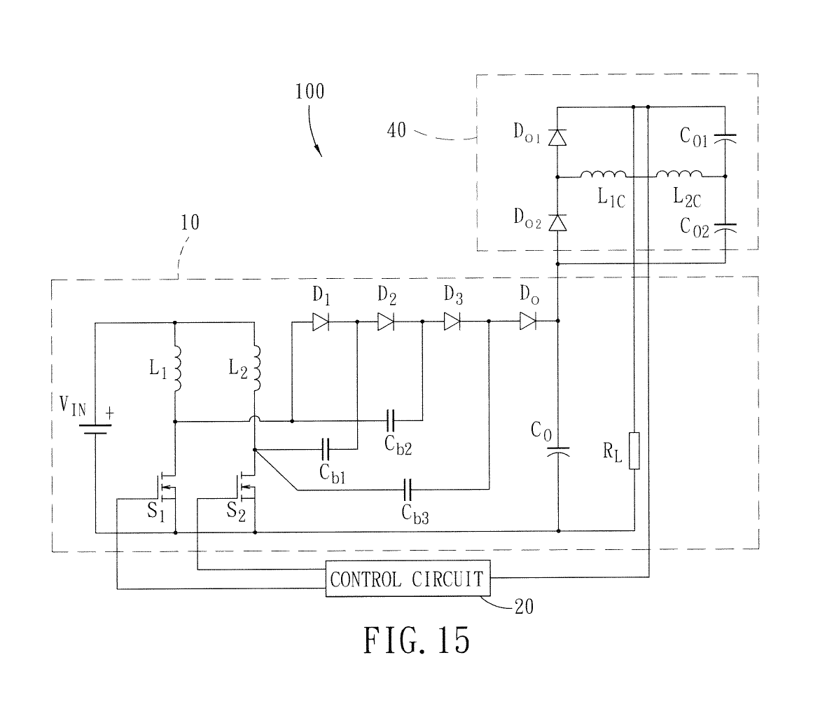

FIG. 15 shows the sixth embodiment of the voltage boosting device 100 of the present invention, wherein the voltage boosting device 100 includes a voltage boosting circuit 10, a control circuit 20 and a sensing voltage booster circuit 40. In this embodiment, the connections and functions of the components in the control circuit 20 and the voltage boosting circuit 10 are the same as those described in the third embodiment, and the connections and functions of the components in the sensing voltage booster circuit 40 are the same as those described in the fourth embodiment.

Therefore, when the first switch S₁ and the second switch S₂ both conduct, the first and second inductors L₁, L₂ will store energy of the power source signal V_{IN}, the first filtering capacitor C_{O1} will store energy of the first coupling inductor L_{1C}, and the second filtering capacitor C_{O2} will store energy of the second coupling inductor L_{2C}.

When the first switch S₁ is not conducting and the second switch S₂ conducts, the first inductor L₁ will release energy to the energy storing elements (the first energy storing element C_{b1} and the third energy storing element C_{b3}) electrically coupled at the junction of the second inductor L₂ and the second switch S₂, and the energy storing element (the second energy storing element C_{b2}) electrically coupled to the junction of the first inductor L₁ and the first switch S₁ will release energy to the output capacitor C_{O}. Meanwhile, the second coupling inductor L_{2C} continues to release energy to the second filtering capacitor C_{O2}.

When the first switch S₁ conducts and the second switch S₂ is not conducting, the energy storing elements (the first energy storing element C_{b1} and the third energy storing element C_{b1}) electrically coupled to the junction of the second inductor L₂ and the second switch S₂ will release energy to the output capacitor C_{O}, and the energy storing element (the second energy storing element C_{b2}) electrically coupled to the junction of the first inductor L₁ and the first switch S₁ will store energy of the first inductor L₁. Meanwhile, the first coupling inductor L_{1C} continues to release energy to the first filtering capacitor C_{O1}. The voltage gain of the voltage boosting circuit 10 of this embodiment is as follows:

$$\frac{4 + 2 N}{1 - D}$$

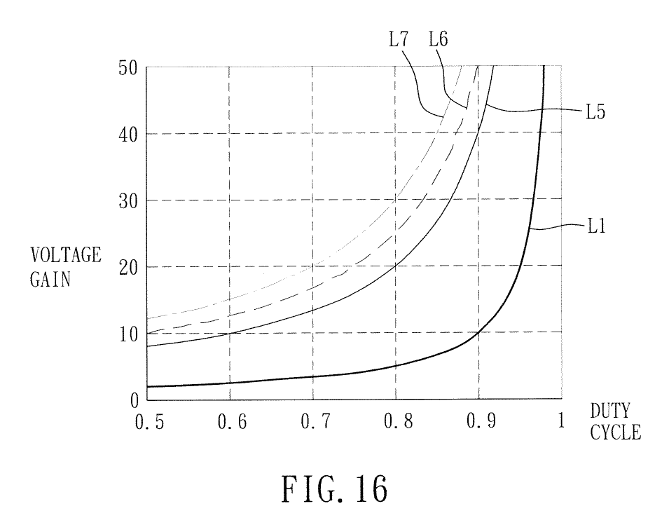

FIG. 16 is a characteristic curve plot illustrating voltage gains of the conventional interleaved voltage boosting circuit and the fourth to sixth embodiments of the voltage boosting circuit 10 of the present invention. The horizontal axis represents the duty cycles of the first and second switches S₁, S₂, and the vertical axis represents the voltage gain. L1 represents the characteristic curve of the conventional interleaved voltage boosting circuit, and L5-L7 represent the characteristic curves of the fourth to sixth embodiments of the voltage boosting circuit 10, respectively. As shown on the characteristic curve plot, the voltage gains in the embodiments of the voltage boosting circuit 10 of the present invention are substantially greater than that of the conventional interleaved voltage boosting circuit, regardless of the duty cycles of the first and second switches S₁, S₂, which means the voltage boosting device 100 of the present invention can indeed increase the overall conversion efficiency and provide a higher voltage power output. The properties of the conventional interleaved voltage boosting circuit and the fourth, fifth and sixth embodiments of the voltage boosting circuit 10 of the present invention are presented in the following table:

TABLE 2

| | Conventional | Voltage boosting circuit of | | |
|---|---|---|---|---|
| | voltage | the present invention | | |
| | boosting | Fourth | Fifth | Sixth |
| | circuit | embodiment | embodiment | embodiment |
| Voltage gain | 1/(1 − D) | $\frac{2 + 2 N}{1 - D}$ | $\frac{3 + 2 N}{1 - D}$ | $\frac{4 + 2 N}{1 - D}$ |
| Voltage across | 1 | 1/(2 + 2N) | 1/(3 + 2N) | 1/(2 + 4N) |
| the switch | | | | |
| Voltage across | 1 | 1/(2 + 2N) | 1/(3 + 2N) | 1/(2 + 4N) |
| the output | | | | |
| diode | | | | |
| Voltage across | — | 2N/(2 + 2N) | 2N/(3 + 2N) | 2N/(2 + 4N) |
| the rectifying | | | | |
| diode | | | | |
| Voltage across | — | 2/(2 + 2N) | 2/(3 + 2N) | 2/(2 + 4N) |
| the clamping | | | | |
| diode | | | | |

The effect of the voltage boosting device 100 of the present invention is to have integrated single-stage power conversion that can achieve high voltage gain in a single power conversion process and high conversion efficiency. Also, without the need of an active circuit control to operate the auxiliary step-up unit 30, the production cost of the voltage boosting device 100 is reduced. Moreover, the voltages of the first switch S₁, the second switch S₂ and the clamping diode D₁ of the voltage boosting circuit 10 are substantially lower than the conventional voltage boosting circuit. Accordingly the conducting and switching losses of the circuit elements, and the problem of reverse recovery loss are all substantially reduced to further increase the conversion efficiency.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A voltage boosting circuit for receiving and boosting a power source signal to be supplied to a load, said voltage boosting circuit comprising:
a first inductor having a first terminal for receiving the power source signal, and a second terminal;
a first switch electrically coupled to said second terminal of said first inductor;
a second inductor having a first terminal for receiving the power source signal, and a second terminal;
a second switch electrically coupled to said second terminal of said second inductor;
a first clamping diode having an anode electrically coupled to a junction of said first inductor and said first switch, and a cathode to be electrically coupled to the load; and
a first energy storing element having a first terminal electrically coupled to a junction of said second inductor and said second switch, and a second terminal electrically coupled to said cathode of said first clamping diode;
wherein when said first switch and said second switch conduct, said first and second inductors are able to store energy of the power source signal;
wherein when said first switch is not conducting and said second switch conducts, said first inductor is able to release energy to said first energy storing element; and
wherein when said first switch conducts and said second switch is not conducting, said second inductor and said first energy storing element are able to release energy to the load.

2. The voltage boosting circuit as claimed in claim 1, further comprising:
an output diode having an anode electrically coupled to said cathode of said first clamping diode, and a cathode to be electrically coupled to the load; and
an output capacitor electrically coupled to said cathode of said output diode.

3. The voltage boosting circuit as claimed in claim 1, further comprising:
a second clamping diode having an anode electrically coupled to said cathode of said first clamping diode, and a cathode to be electrically coupled to the load; and
a second energy storing element having a first terminal, electrically coupled to said junction of said first inductor and said first switch, and a second terminal electrically coupled to said cathode of said second clamping diode;
wherein when said first switch is not conducting and said second switch conducts, said second energy storing element is able to release energy to the load; and
wherein when said first switch conducts and said second switch is not conducting, said first inductor is able to release energy to said second energy storing element.

4. The voltage boosting circuit as claimed in claim 3, further comprising:
an output diode having an anode electrically coupled to said cathode of said second clamping diode, and a cathode to be electrically coupled to the load; and
an output capacitor electrically coupled to said cathode of said output diode.

5. The voltage boosting circuit as claimed in claim 4, further comprising a sensing voltage booster circuit, said sensing voltage booster circuit including:
a first rectifying diode having an anode and a cathode, said cathode of said first rectifying diode to be electrically coupled to the load;
a second rectifying diode having an anode electrically coupled to said cathode of said output diode, and a cathode electrically coupled to said anode of said first rectifying diode;
a first filtering capacitor having a first terminal electrically coupled to said cathode of said first rectifying diode, and a second terminal;
a second filtering capacitor having a first terminal electrically coupled to said second terminal of said first filtering capacitor, and a second terminal electrically coupled to said anode of said second rectifying diode;
a first coupling inductor cooperating with said first inductor to form a transformer, said first coupling inductor having a first terminal electrically coupled to said cathode of said second rectifying diode, and a second terminal; and
a second coupling inductor cooperating with said second inductor to form another transformer, said second coupling inductor having a first terminal electrically coupled to said second terminal of said first coupling inductor, and a second terminal electrically coupled to a junction of said first filtering capacitor and said second filtering capacitor;
wherein when said first switch conducts, said first coupling inductor is able to release energy to said first filtering capacitor;
wherein when said second switch conducts, said second coupling inductor is able to release energy to said second filtering capacitor; and
wherein when said first switch conducts and said second switch is not conducting, said first filtering capacitor and said second filtering capacitor are able to release energy to the load.

6. The voltage boosting circuit as claimed in claim 2, further comprising a sensing voltage booster circuit, said sensing voltage booster circuit including:
a first rectifying diode having an anode and a cathode, said cathode of said first rectifying diode to be electrically coupled to the load;
a second rectifying diode having an anode electrically coupled to said cathode of said output diode, and a cathode electrically coupled to said anode of said first rectifying diode;
a first filtering capacitor having a first terminal electrically coupled to said cathode of said first rectifying diode, and a second terminal;
a second filtering capacitor having a first terminal electrically coupled to said second terminal of said first filtering capacitor, and a second terminal electrically coupled to said anode of said second rectifying diode;
a first coupling inductor cooperating with said first inductor to form a transformer, said first coupling inductor having a first terminal electrically coupled to said cathode of said second rectifying diode, and a second terminal; and
a second coupling inductor cooperating with said second inductor to form another transformer, said second coupling inductor having a first terminal electrically coupled to said second terminal of said first coupling inductor, and a second terminal electrically coupled to a junction of said first filtering capacitor and said second filtering capacitor;
wherein when said first switch conducts, said first coupling inductor is able to release energy to said first filtering capacitor;
wherein when said second switch conducts, said second coupling inductor is able to release energy to said second filtering capacitor; and
wherein when said first switch conducts and said second switch is not conducting, said first filtering capacitor and said second filtering capacitor are able to release energy to the load.

7. A voltage boosting device for receiving and boosting a power source signal to be supplied to a load, said voltage boosting device comprising:
a control circuit; and
a voltage boosting circuit including:
a first inductor having a first terminal for receiving the power source signal, and a second terminal;
a first switch electrically coupled to said second terminal of said first inductor;
a second inductor having a first terminal for receiving the power source signal, and a second terminal;
a second switch electrically coupled to said second terminal of said second inductor;
said first switch and said second switch being controlled by said control circuit to conduct or not conduct;
a first clamping diode having an anode electrically coupled to a junction of said first inductor and said first switch, and a cathode to be electrically coupled to the load; and
a first energy storing element having a first terminal electrically coupled to a junction of said second inductor and said second switch, and a second terminal electrically coupled to said cathode of said first clamping diode;
wherein when said first switch and said second switch conduct, said first and second inductors are able to store energy of the power source signal;
wherein when said first switch is not conducting and said second switch conducts, said first inductor is able to release energy to said first energy storing element; and
wherein when said first switch conducts and said second switch is not conducting, said second inductor and said first energy storing element are able to release energy to the load.

8. The voltage boosting device as claimed in claim 7, wherein said voltage boosting circuit further includes:
an output diode having an anode electrically coupled to said cathode of said first clamping diode, and a cathode to be electrically coupled to the load; and
an output capacitor electrically coupled to said cathode of said output diode.

9. The voltage boosting device as claimed in claim 7, wherein said voltage boosting circuit further includes:
a second clamping diode having an anode electrically coupled to said cathode of said first clamping diode, and a cathode to be electrically coupled to the load; and
a second energy storing element having a first terminal electrically coupled to said junction of said first inductor and said first switch, and a second terminal electrically coupled to said cathode of said second clamping diode;
wherein when said first switch is not conducting and said second switch conducts, said second energy storing element is able to release energy to the load; and
wherein when said first switch conducts and said second switch is not conducting, said first inductor is able to release energy to said second energy storing element.

10. The voltage boosting device as claimed in claim 9, wherein said voltage boosting circuit further includes:
an output diode having an anode electrically coupled to said cathode of said second clamping diode, and a cathode to be electrically coupled to the load; and
an output capacitor electrically coupled to said cathode of said output diode.

11. The voltage boosting device as claimed in claim 10, wherein said voltage boosting circuit further includes a sensing voltage booster circuit, said sensing voltage booster circuit including:
a first rectifying diode having an anode and a cathode, said cathode of said first rectifying diode to be electrically coupled to the load;
a second rectifying diode having an anode electrically coupled to said cathode of said output diode, and a cathode electrically coupled to said anode of said first rectifying diode;
a first filtering capacitor having a first terminal electrically coupled to said cathode of said first rectifying diode, and a second terminal;
a second filtering capacitor having a first terminal electrically coupled to said second terminal of said first filtering capacitor, and a second terminal electrically coupled to said anode of said second rectifying diode;
a first coupling inductor cooperating with said first inductor to form a transformer, said first coupling inductor having a first terminal electrically coupled to said cathode of said second rectifying diode, and a second terminal; and
a second coupling inductor cooperating with said second inductor to form another transformer, said second coupling inductor having a first terminal electrically coupled to said second terminal of said first coupling inductor, and a second terminal electrically coupled to a junction of said first filtering capacitor and said second filtering capacitor;
wherein when said first switch conducts, said first coupling inductor is able to release energy to said first filtering capacitor;
wherein when said second switch conducts, said second coupling inductor is able to release energy to said second filtering capacitor; and
wherein when said first switch conducts and said second switch is not conducting, said first filtering capacitor and said second filtering capacitor are able to release energy to the load.

12. The voltage boosting device as claimed in claim 8, wherein said voltage boosting circuit further includes a sensing voltage booster circuit, said sensing voltage booster circuit including:
a first rectifying diode having an anode and a cathode, said cathode of said first rectifying diode to be electrically coupled to the load;
a second rectifying diode having an anode electrically coupled to said cathode of said output diode, and a cathode electrically coupled to said anode of said first rectifying diode;
a first filtering capacitor having a first terminal electrically coupled to said cathode of said first rectifying diode, and a second terminal;
a second filtering capacitor having a first terminal electrically coupled to said second terminal of said first filtering capacitor, and a second terminal electrically coupled to said anode of said second rectifying diode;
a first coupling inductor cooperating with said first inductor to form a transformer, said first coupling inductor having a first terminal electrically coupled to said cathode of said second rectifying diode, and a second terminal; and
a second coupling inductor cooperating with said second inductor to form another transformer, said second coupling inductor having a first terminal electrically coupled to said second terminal of said first coupling inductor, and a second terminal electrically coupled to a junction of said first filtering capacitor and said second filtering capacitor;
wherein when said first switch conducts, said first coupling inductor is able to release energy to said first filtering capacitor;
wherein when said second switch conducts, said second coupling inductor is able to release energy to said second filtering capacitor; and
wherein when said first switch conducts and said second switch is not conducting, said first filtering capacitor and said second filtering capacitor are able to release energy to the load.
